(19) United States
(12) Patent Application Publication
(10) Pub. No.: US 2016/0165409 A1
(43) Pub. Date: Jun. 9, 2016

(54) METHOD AND DEVICE FOR WEARABLE DISPLAY

(71) Applicant: KONINKLIJKE PHILIPS N.V., EINDHOVEN (NL)

(72) Inventors: MURTAZA BULUT, EINDHOVEN (NL); JAN MARTIJN KRANS, DEN BOSCH (NL); JOHN CRONIN, BONITA SPRINGS, FL (US)

(21) Appl. No.: 14/956,829

(22) Filed: Dec. 2, 2015

Related U.S. Application Data
(60) Provisional application No. 62/087,197, filed on Dec. 3, 2014.

(30) Foreign Application Priority Data
Jun. 4, 2015 (EP) 15170673.6

(51) Int. Cl. H04W 4/06; H04W 4/00; G06F 1/16

(52) U.S. Cl. CPC H04W 4/06; G06F 1/163; H04W 4/008

(57) ABSTRACT

In one embodiment, an apparatus having a processor configured to receive an indication that a plurality of devices is located within a defined proximity to the apparatus, determine which of those devices belong to a predetermined group, receive physiological or behavioral data associated with each device of the predetermined group, and provide information to all or a combination of the group of devices and a second device based on a total value corresponding to the received physiological or behavioral data satisfying a predetermined condition.

### CROSS-REFERENCE TO RELATED APPLICATION

The present invention claims the priority benefit of U.S. provisional patent application 62/087,197 filed Dec. 3, 2014 and titled “Ubiquitous Wearable Display,” the disclosure of which is incorporated herein by reference.

### FIELD OF THE INVENTION

The present invention generally relates to wearable technology.

### BACKGROUND OF THE INVENTION

Wearable technology includes devices that can be worn on the body or attached to or embedded in clothes and accessories of an individual. Processors and sensors associated with the wearable technology can gather, process, and display activity-related data, such as health or fitness related data, to a user. Data gathered from wearable devices may be utilized for purposes other than health or fitness. For instance, U.S. Patent Publication no. 2008/0146892 refers to a method of delivering targeted advertising to a person based on collecting physiological and/or environmental information from a monitoring device having at least one physiological sensor and/or environmental sensor and selecting an advertisement for delivery to the person based on the collected information. The delivery may be achieved by email, postal mail, television, radio, newspaper, magazine, the Internet, and outdoor advertising.

### SUMMARY OF THE CLAIMED INVENTION

Embodiments of the present invention include an apparatus having a processor configured to receive an indication that a plurality of devices is located within a defined proximity to the apparatus, determine which of those devices belong to a predetermined group, receive physiological or behavioral data associated with each device of the predetermined group, and provide information to all or a combination of the group of devices and a second device based on a total value corresponding to the received physiological or behavioral data satisfying a predetermined condition.

Further embodiments of the invention include a system having a processor configured to receive an indication that a plurality of devices located within a defined proximity to the processor, receive physiological or behavioral data and additional information associated with the plurality of devices, determine whether to provide a message to at least one of the plurality of devices or to a second device based on the additional information, and provide the message to the at least one of the plurality of devices or the second device.

Further embodiments of the invention include an apparatus having a display screen and a coupled processor configured to receive an indication that at least one device is located within a defined proximity to the processor, receive physiological or behavioral data associated with the device, present a web-page corresponding to commerce activities, and provide an actionable and measureable incentive associated with product or services associated with the web-page based on the physiological or behavioral data.

These and other aspects of the invention will be apparent from and elucidated with reference to the embodiment(s) described hereinafter.

### BRIEF DESCRIPTION OF THE DRAWINGS

Many aspects of the invention can be better understood with reference to the following drawings, which are diagrammatic. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram that illustrates an example network environment in which an example wearable data based targeting system may be implemented in accordance with an embodiment of the invention.

FIG. 2 is a flow diagram that illustrates an example wearable data based targeting method in accordance with an embodiment of the invention.

FIG. 3 is a block diagram that illustrates example components of a computing device embodied as an example smart TV that may be used in a wearable data based targeting system in accordance with an embodiment of the invention.

FIGS. 4A-B are flow diagrams that illustrate some example smart TV and mobile device methods that may be used in a wearable data based targeting system in accordance with an embodiment of the invention.

FIG. 5A is a schematic diagram that illustrates an example database that may be used in a wearable data based targeting system in accordance with an embodiment of the invention.

FIG. 5B is a flow diagram that illustrates an example advertising targeting method that may be used in a wearable data based targeting system in accordance with an embodiment of the invention.

FIG. 6 is a flow diagram that illustrates an example wearable data based targeting method in accordance with an embodiment of the invention.

FIG. 7 is a schematic diagram that illustrates an example computing device embodied as a mobile device that may be used in a wearable data based targeting system in accordance with an embodiment of the invention.

FIGS. 8-10 are flow diagrams that illustrate some example wearable data based targeting methods in accordance with an embodiment of the invention.

### DETAILED DESCRIPTION OF EMBODIMENTS

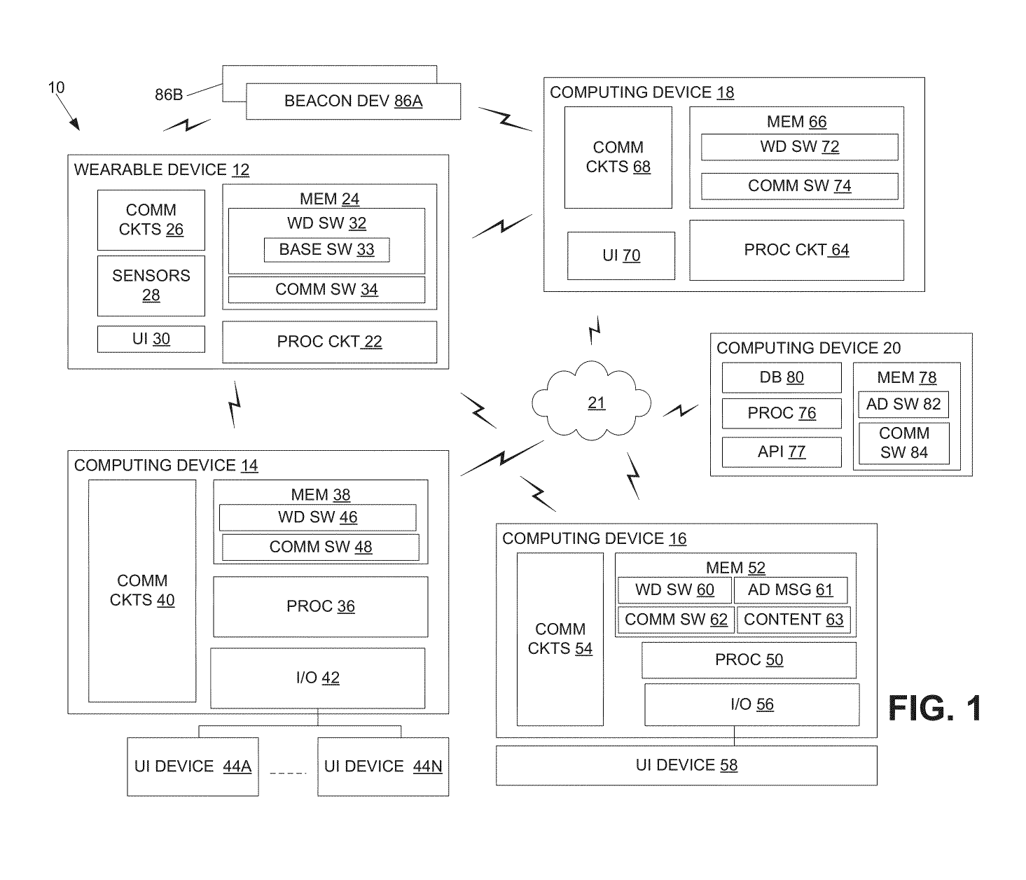

FIG. 1 is a schematic diagram that illustrates an example network environment 10 in which an example wearable data based targeting system may be implemented in accordance with an embodiment of the invention. It should be appreciated by one having ordinary skill in the art in the context of the present disclosure that the example network environment is illustrative of one embodiment, and that some embodiments may have fewer, additional, and/or different components. Shown in the depicted environment 10 is a wearable device 12 and a plurality of computing devices 14, 16, 18, and 20. The computing device 14 is embodied as a (retail) point of sale (POS) computing device, which resides at a store that sells merchandise. The computing device 16 is embodied as a smart TV, such as one residing within a person or users home. In some embodiments, the computing device 16 may be embodied as a personal computer. The computing device 18 is embodied as a phone, such as a smartphone, though other mobile devices may be used, such as a laptop, tablet, personal digital assistant, among others. The computing device 20 is embodied as an advertiser computer, such as a server. The computing device 20 may reside within, or be associated with, one or more companies representing the source of the advertising, an advertising company or agency that provides advertising from the companies, or a third party provider that electronically delivers the advertisements for the advertising company or the company for which the advertisements are for their products or services. Hereinafter, the computing devices 14, 16, and 18 are referred to also as a POS computing device 14, smart TV 16, and smartphone 18, respectively, with the understanding that each computing device 14, 16, and 18 may be embodied as another type of computing device in some embodiments. Also note that the “lightning bolt” arrows in FIG. 1 represent that the wearable device 12 and the computing devices 14, 16, 18, and 20 are in wireless and/or wired communication with each other as shown, either directly or via a network 21. In one embodiment, the network 21 comprises one or more networks, including the Internet 21. As exemplified by the computing device 14, some computing devices may be used in public and may therefore be accessible via an unsecured wireless connection. Alternatively, some computing devices, such as the computing device 16, which may reside in a person's home, may only be accessible via a secured wireless connection.

In one embodiment, the wearable device 12 comprises a processing circuit 22, memory 24, communications circuitry 26, sensors 28, and a user interface 30, which in one embodiment, comprises a display screen and/or buttons that enable a user to provide input to and/or receive output (e.g., a visual representation) from the wearable device 12. In general, the wearable device 12 is typically worn by the person (e.g., around the wrist). The processing circuit 22 may include a microcontroller, digital signal processor, or combination thereof, and may further include additional signal processing circuitry (e.g., analog to digital converters, digital to analog converters, signal conditioning, amplifiers, etc.). The communications circuitry 26 includes transceiver circuitry operable according to any one or a plurality of different communication standards, specifications, and/or protocols, including near field communication (NFC), low-power Bluetooth (in including iBeacon, AltBeacon, URIBeacon, Eddystone, etc.), Zigbee, wireless fidelity (WiFi), etc. The sensors 28 may be embodied as inertial sensors (e.g., gyroscopes, single or multi-axis accelerometers, such as those using piezoelectric, piezoresistive or capacitive technology in a microelectromechanical system (MEMS) infrastructure), flex and/or force sensors (e.g., using variable resistance), electromyographic sensors, electrocardiographic sensors (e.g., EKG, ECG) magnetic sensors, photoplethysmographic (PPG) sensors, bio-impedance sensors, infrared proximity sensors, acoustic/ultrasonic/audio sensors, a strain gauge, galvanic skin/sweat sensors, pH sensors, temperature sensors, pressure sensors, and photocells. In some embodiments, other types of sensors 28 may be used to facilitate health and/or fitness related computations, including a global navigation satellite systems (GNSS) sensor (e.g., global positioning system (GPS) receiver) to facilitate determinations of distance, speed, acceleration, location, altitude, etc. (e.g., location data and movement), barometric pressure, humidity, outdoor temperature, etc. The wearable device 12 further includes software/firmware in memory 24, including wearable device software (WD SW) 32, base software 33, and communications software (COMM SW) 34. The wearable device software 32 provides for command and control of the wearable device, and the communications software 34 works in conjunction with the communications circuitry 26 to communicate (wirelessly or over a wired medium, such as a universal serial bus or USB) the physiological and/or behavioral data detected by the sensors 28 to a computing device, such as one or more of computing devices 14, 16, and/or 18. In one embodiment, the wearable device 12 comprises thumbnail data that includes an identification of the wearable device 12, a group member ID, location information, device information, and physiological or behavioral data. In some embodiments, the thumbnail data may include additional information, such as whether the wearable device 12 comprises a display screen, information about members of the group or friends (e.g., a weighting of the closeness of friends, etc.), and information about user preferences pertaining to communications of information (e.g., a preferred frequency of receiving information, the preferred content of the information, the security level, etc.). The communications software 34 includes a thumbnail application that allows for communication with the computing devices 14, 16, and/or 18. The communications software 34 further includes functionality to receive beacons provided by beacon devices 86 (e.g., 86A, 86B) residing in various locations within a store, the beacon devices 86 comprising low power Bluetooth transmitters and/or transceivers with a processor running software. The beacon devices 86 provide beacons to one or more of the computing devices (e.g., computing devices 14, 16), and may be dispersed in a plurality of locations throughout a store, including proximal to second devices (e.g., display screens for presenting content, such as user-specific advertisements, promotions, advice, etc.) to enable a determination of the proximity of one or more persons (e.g., based on user ID, member ID, etc. provided via the thumbnail data) to the display screens. The beacons provided by the beacon devices 86 may include an address or link(s) to various information, such as advertisements. In one embodiment, the beacons emitted by the beacon devices 86 use Bluetooth low energy proximity sensing to transmit a universally unique identifier^{]} picked up by a compatible app or operating system (e.g., wearable device software 32, 46, 72, etc.). The identifier and several bytes sent with it may be used to determine the device's physical location, track customers, or trigger a location-based action on the device such as a check-in on social media or a push notification. An example use of the wearable device 12 operating with the beacon devices 86 may involve a user wearing a wearable device 12 arriving at a shop and making a purchase. When the beacon from the beacon device 86 is read, a trigger may be sent to the wearable device 12 that points the user to a website address (e.g., identified by web address) where a coupon may be downloaded or otherwise accessed. Note that other mechanisms may be used to detect the proximity of a person to a device within a store (or close to a computing device such as a smart TV 16 at home), such as via Wi-Fi (e.g., RSSI signal strength detection), Global Navigation Satellite Systems (GNSS) technology, etc.

The smartphone 18 comprises a processing circuit 64, memory 66, communications circuitry 68, and a user interface device 70. The processing circuit 64 may include one or more processors, such as a microcontroller, digital signal processor, or combination thereof, and may further include additional signal processing circuitry (e.g., analog to digital converters, digital to analog converters, signal conditioning, amplifiers, filters, etc.). The communications circuitry 68 includes transceiver circuitry operable according to any one or a plurality of different communication standards, specifications, and/or protocols, including near field communication (NFC), low-power Bluetooth (in including iBeacon, AltBeacon, URIBeacon, Eddystone, etc.), Zigbee, wireless fidelity (WiFi), etc. More particularly, the processor may comprise a baseband processor that deploys functionality of a GSM protocol stack to enable the smartphone 18 to access one or a plurality of wireless network technologies, including WCDMA (Wideband Code Division Multiple Access), CDMA (Code Division Multiple Access), EDGE (Enhanced Data Rates for GSM Evolution), GPRS (General Packet Radio Service), Zigbee (e.g., based on IEEE 802.15.4), near field communications, Bluetooth (including low-power Bluetooth), Wi-Fi (Wireless Fidelity, such as based on IEEE 802.11), and/or LTE (Long Term Evolution), among variations thereof and/or other telecommunication protocols, standards, and/or specifications. The memory 66 may comprise wearable device software (WD SW) 72 that works in conjunction with the wearable device 12 and communications software 74. The thumbnail application on the wearable device 12 may, in conjunction with the smartphone 18 and the POS computing device 14, allow the user to process a payment using near field communications technology.

The (retail) POS computing device 14 may connect through the backbone to the cloud or the Internet 21. In one embodiment, the POS computing device 14 comprises a processor 36, memory 38, communications circuitry 40, and an input/output (I/O) interface 42, which enables wired and/or wireless communications with one or more user interface (UI) devices 44A-44N. For instance, the UI devices 44 may be dispersed throughout a store for presenting information (e.g., actionable and measureable incentives, such as coupons, promotional material, etc.) and/or messages (e.g., the information mentioned previously and/or advice or personalized messages). The UI devices 44 may be embodied as display screens, speakers, and/or other devices that present visual and/or audio representations of the messages and/or information. The UI devices 44 may be co-located with the processor 36, or located remotely from the processor 36 yet in communications with the UI devices 44. The UI devices 44 may also be proximally co-located with one or more beacon devices 86. Note that the UI devices 44 are also referred to herein as second devices.

The memory 38 comprises wearable device software (WD SW) 46 and communications software (COMM SW) 48. The wearable device software (WD SW) 46 enables operations with the wearable device 12, such as the ability to access physiological and/or behavioral data (and other information, such as user profiles, including gender, age, BMI, device information, such as whether the wearable device 12 is equipped with a display screen, etc.) directly from the wearable device 12 or via the smartphone 18 or the server 20. The communications software (COMM SW) 48 may comprise all or at least a portion of the communications functionality of the smartphone 18. In one embodiment, the POS computing device 14 may access user information (e.g., identifier, purchasing information, messaging/information history, membership within a group, such as a member ID) from other devices (e.g., the wearable device 12, the smartphone 18, the server 20) for customizing or personalizing coupons and/or messaging or making determinations on targeting among plural users co-located within a store.

The smart TV 16 comprises a processor 50, memory 52, communications circuitry 54, an I/O interface 56, and one or more UI devices 58 (e.g., visual and/or audio device(s)) coupled to the processor 50 via the I/O interface 56. The memory 52 comprises wearable device software (WD SW) 60, advertisement messaging software (AD MSG) 61, communications software 62, and content 63, among other applications, such as Web commerce applications, browser functionality, etc. The communications circuitry 54 may comprise all or a portion of the functionality previously described for the smartphone 18. The WD software 60, like the software of a like-name described previously, enables the reading of the wearable device 12 and access to information associated with the wearable device 12 (whether directly via the wearable device 12 or indirectly, such as via the smartphone 18 and/or the server 20). The advertisement messaging software 61, in association with the UI device 58, may be used to present the content 63 in the form of advertising and/or other messaging.

The server 20 comprises a processor 76, an application programming interface (API) 77, memory 78, and a data structure, such as an advertisement database (DB) 80 coupled thereto. The memory 78 comprises advertisement software 82 and communications software 84. Though shown as a single device, it should be appreciated that a greater quantity of devices may be used to provide the advertisements and/or store user information. As indicated previously, the server 20 may be associated with any group of advertisers or third party services associated with the advertisers. The server 20 may use the API 77 and the advertisement software 82 to communicate with other devices in the system, add to, or modify the content of, advertisements in the advertising database 80, and communicate and run processes (e.g., use and update the database, deliver coupons, messaging, etc.).

The server 20 may provide a variety of advertising content and a set of desired user parameters to be used to target each advertisement. Such advertising content or advertisements may include coupons, promotional offers, and other motivational messages. Further, the user parameters may include a variety of demographic information useful for target advertising, including sex/gender, age range, etc. In addition, the advertisers may further specify any parameter that may be related to wearable device data, including activity level, types of activity, health-related parameters, etc.

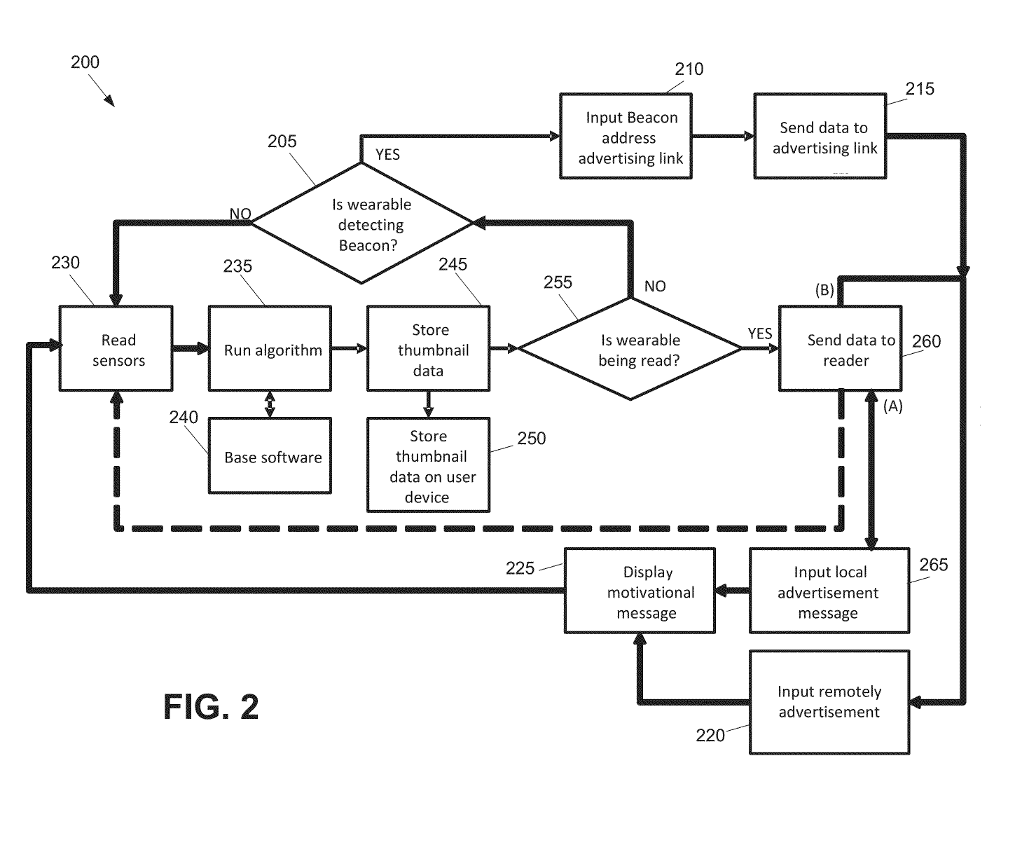

FIG. 2 is a flow diagram that illustrates an embodiment of an example wearable data based targeting method 200. The method 200 may involve the interplay of plural computing devices described in association with FIG. 1. The sensors of the wearable device 12 (FIG. 1) may be read (e.g., by the wearable device software 32, FIG. 1) in step 230, and a set of algorithms may be run on the sensor data to produce thumbnail data in step 235. The wearable device 12 generally allows the user to perform basic functions such as, for example, charging, recharging, starting and stopping, resetting, requesting display information, etc. The wearable device 12 also runs the base software (step 240) of the wearable device software 32, which is used to execute the one or more algorithms pertaining to the processing of the physiological or behavioral data, such as determining steps, heart rate, etc. The output of the algorithms may be stored within memory 24 (FIG. 1) of the wearable device 12 (step 245) and referred to as thumbnail data. Such thumbnail data might be a number of highest steps today, average steps over the last month, a measurement of calories consumed, blood pressure, glucose level, etc. Such thumbnail data may be communicated to another computing device having wearable device software, such as the smartphone 18, the POS computing device 14, and/or the smart TV 16 (step 250).

Different types of thumbnail data may be generated for different contexts. For example, thumbnail data may be anonymized or otherwise include less data (or data that is less likely to identify the user) when used in open or unsecured communication networks. Rather than specifically identifying the user or providing identifying information regarding the user, the thumbnail data may only indicate that the user is a woman in her mid-fifties and the number of steps she has taken that day. In response to such data, an advertisement software 82 run on the server 20 (FIG. 1) (or like-functionality run on the POS computing device 14 or in the smart TV 16) may designate that a message be displayed with a congratulatory note on the number of steps she has taken that day and also provide a coupon for a brand of shoes known to be popular in her age group. Alternatively, the thumbnail data may indicate a temperature or blood glucose level and provide information such as advice, a promotional coupon, etc. for a particular product or service that influences or motivates the user to purchase a particular beverage or other refreshment/snack based on the information.

Conversely, the presence of secured networks may allow more detailed thumbnail data to be shared. For example, the user of the wearable device may be identified as having used the secured network previously. For such a user, the thumbnail data may further include a user identifier, birthday, anniversaries, frequent flier/shopper accounts, past shopping history, etc. Such information allows for even more detailed targeting with respect to advertising and motivational messages.

It may then be determined (e.g., by the wearable device 12, FIG. 1) in step 255 whether the wearable device is being read by a computing device, such as one equipped with low-power Bluetooth communications capabilities, a wearable device reader, etc. If the wearable device 12 detects that it is being read (e.g., via low-power Bluetooth or Wi-Fi functionality of one or more of the computing devices 14, 16, 18, FIG. 1), the wearable device 12 may automatically synchronize with the reading device, and send its data to the reading device in step 260.

Such data sent from the wearable device 12 (FIG. 1) may include the thumbnail data, which may include profile data (e.g., user ID, member ID, etc.). Subsequently, the method may proceed along the (A) path to step 265 where the data may be incorporated into a local (e.g., stored locally and writeable) or remote advertisement, and such information may be sent back in real-time. Such incorporation may result in a display (or generally, a presentation, such as on the UI devices 30, 44, 58, 70, FIG. 1) of information or a message (e.g., a motivational message, an offer, a coupon, or other type of deal or actionable and measureable incentive) in step 225. Such information or message may also be displayed at the same time on more than one device, or restricted to a subset of devices (e.g., one or more devices to the exclusion of other devices).

Alternatively, the method 200 may proceed along the (B) path where the data may be sent remotely back (e.g., via the Internet 21 or other network) in step 220. Such data may be sent up to the server 20 (e.g., using a cloud platform or otherwise), run on a corresponding data or computer system, and then sent back down with information and/or messaging in step 225.

If the wearable device 12 (FIG. 1) detects a beacon in step 205, the wearable device 12 may send an address and advertising link along with the data (e.g., thumbnail data) in step 210. The advertising link may enable the recipient to access the advertisement remotely via Wi-Fi through the Internet 21 (FIG. 1) in step 215. As such, the beacon may trigger off a link to be sent to the wearable device 12 in step 220, which may read it when in range and then send its thumbnail data (including the user ID (if needed)) to that link through the Wi-Fi connection of the wearable device 12. Such linking may occur at the smartphone 18 (FIG. 1), which may result in incorporation of the wearable data into an advertisement remotely from the smartphone 18, which may then be displayed (e.g., as a message in step 225). If the wearable device detection of the beacon is not detected, the wearable device 12 may continue reading through the sensor(s) in step 230.

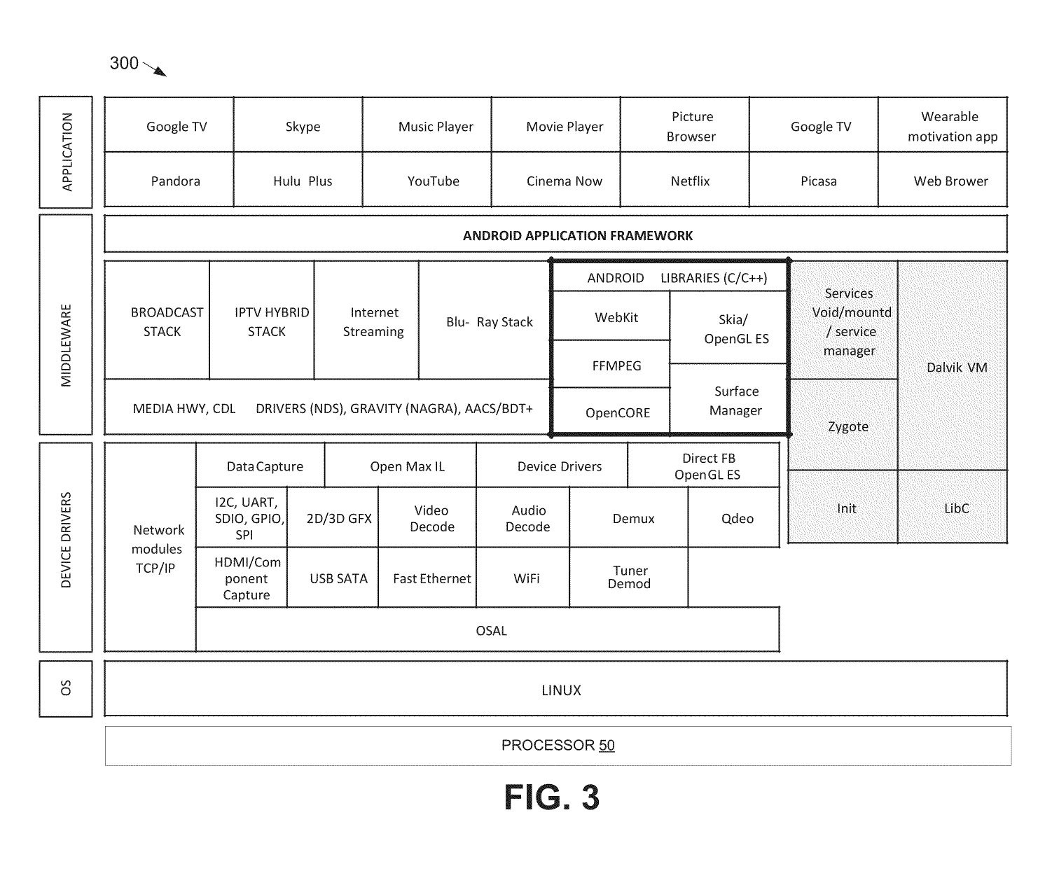

FIG. 3 illustrates example components of a computing device embodied as an example smart TV 300 that may be used in a wearable data based targeting system. In one embodiment, the smart TV 300 may include the smart TV 16 depicted in FIG. 1. As illustrated, the smart TV 300 allows for various applications to be loaded thereon, such as Netflix, Google TV, etc. An application specific to wearable devices may be loaded in a similar fashion, and such application may be executed in accordance with embodiments of the present invention described herein. In that regard, a wearable device application may provide for presentation of wearable device-based data at the smart TV 300. When executed, such an application may detect the presence of the wearable device 12 within a range, identify the wearable device 12, run one or more algorithms, access the advertising database 80 (FIG. 1) via the Internet 21 (FIG. 1), and retrieve information and/or messages, such as motivational information, user-specific messages, coupons, offers, etc. Such information/messages may then be displayed on a screen (e.g., user interface device 58) of the smart TV 300. The smart TV 300 comprises multiple levels of functionality, including applications, middleware, device drivers, (collectively, the applications and middleware and drivers referred to as software), the operating system (O.S.), and the processor 50.

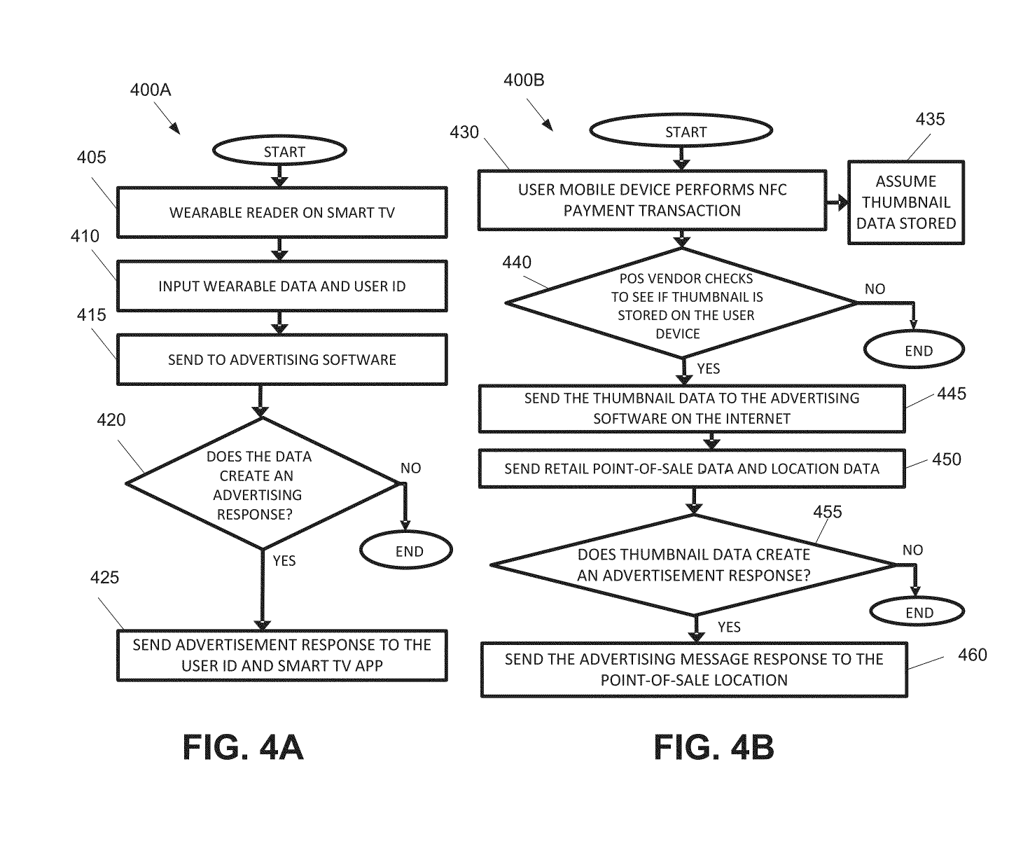

FIGS. 4A-4B are flow diagrams that illustrate some example smart TV and mobile device methods 400A and 400B, respectively, that may be used in a wearable data based targeting system. In FIG. 4A, a smart TV method 400A may involve installing or otherwise configuring a wearable device reader (e.g., wearable device software 60, FIG. 1) on the smart TV 16 in step 405 (e.g., inputting wearable device data or user ID in step 410). Such information may be sent up to an advertising software server in the cloud in step 415. If the data is determined to create an advertising response in step 420, then an advertising message response may be sent to the wearable device 12 (FIG. 1) identified by the user ID and to the smart TV app for display in step 425. If there is no response, no coupon may be provided.

The mobile device method 400B may include the smartphone 18 (also referred to as a user mobile device in FIG. 4B) performing an NFC payment transaction in step 430 where thumbnail data may be stored with the user ID in step 435. The POS computing device 14 (FIG. 1) may check to see if the thumbnail is stored on the smartphone 18 (user mobile device) in step 440. If so, it may then be determined whether the POS computing device 14 or user device may have a wearable device 12 connected. If so, the thumbnail data may be sent to the advertising software in the cloud in step 445, and the retail point-of-sale data and location data may be sent to the cloud in step 450. It may then be determined whether the thumbnail data creates an advertisement response in step 455. If so, the advertising message response may be sent to the POS computing device 14 for delivery to the user in step 460. If not, the method may end. If no thumbnail data is determined to be stored on the user device in step 440, the method may end. Likewise, if no thumbnail data is determined to create an advertisement response in step 455, the method may end.

In some embodiments, it may actually be the wearable device 12 (FIG. 1) that has NFC communications capability. In that case, the wearable device 12 might itself provide the NFC translation data.

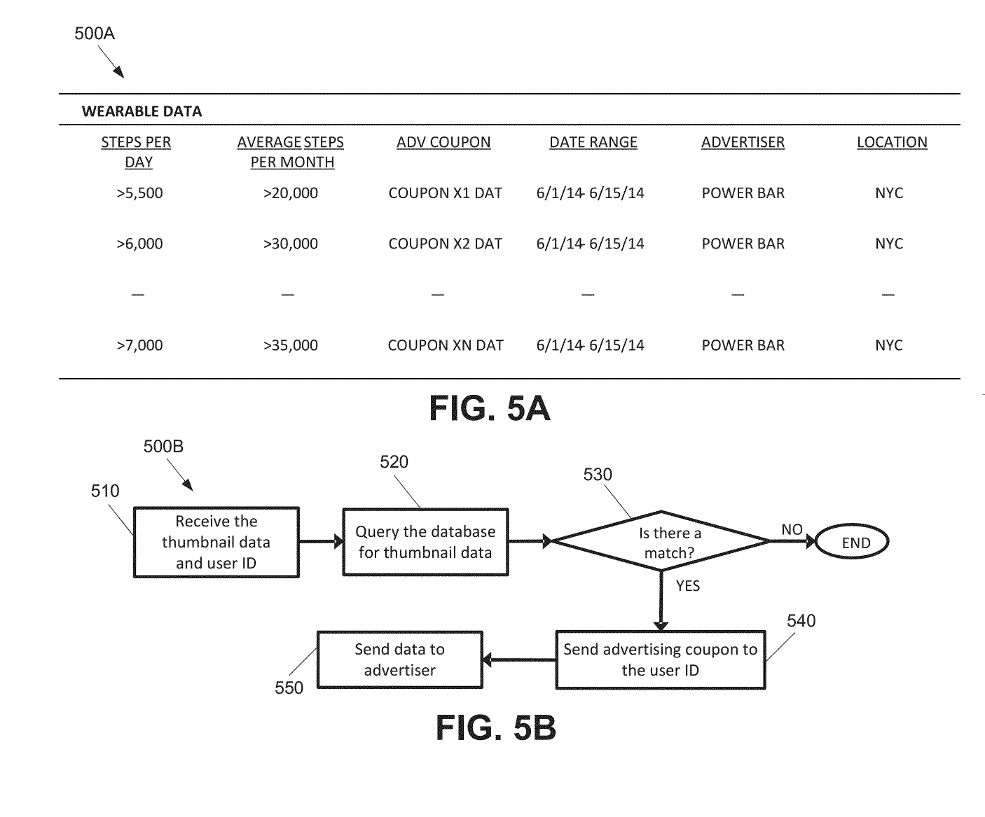

FIG. 5A illustrates an example database 500A that may be used in a system for providing a ubiquitous wearable display, and FIG. 5B is a flow diagram that illustrates an example advertising targeting method that may be used in a wearable data based targeting system. Such a database 500A may store wearable data regarding such parameters as steps per day and average steps per month (e.g. thumbnail data). Such data may be categorized into ranges (e.g., greater than 5,500 or greater than 20,000 steps per month). The database 500A may correspond to database 80 associated with the server 20 (FIG. 1), a database associated with the POS computing device 14, or a database stored associated with the smart TV 16. The advertising coupon may be stored in a file called couponX1.dat. The date range may be shown. As illustrated, the advertisers may also be identified (e.g., Power Bar) and location (e.g., New York City).

An advertising database 500A may receive thumbnail data and user ID in step 510. The database 500A may be queried regarding the thumbnail data in step 520. For example, a number of daily steps that is more than 6,000 and an average number of monthly steps that is more than 30,000 may trigger the retrieval of couponX.2.dat within the designated date range. If a match is identified for the thumbnail data in the database in step 530, the advertisement software 82 may be notified, and the advertising coupon may be sent to the device with the user ID in step 540, and then the data may be sent to the server 20 associated with the advertiser in step 550.

In previously described embodiments, the content of the information and/or messages, such as the amount of discount offered via a coupon locally in a store via the wearable device 12 and/or smartphone 18 (FIG. 1) of the customer depends on physiological or behavioral performance of the customer (e.g., total step count for that day or month). In this way, customers can be motivated towards healthier behavior (e.g., enhanced activity level) by offering them a higher discount. In some embodiments, the content of the information/message offered locally near a beacon in a store not only depends on behavioral performance of a single customer, but of the total performance of a group of customers visiting the shop together. In this way, adapted product/discount offerings can be offered by the shop to all customers within this visiting group. These dedicated offerings for social groups, which in one embodiment may be dependent on an average of individual health related parameter values from the group members (e.g., average step count of the group for that day), are beneficial for both shop and group members. In other words, group members are motivated even more towards healthier behavior by social/peer pressure, and at the same time, social traffic in the shop is enhanced.

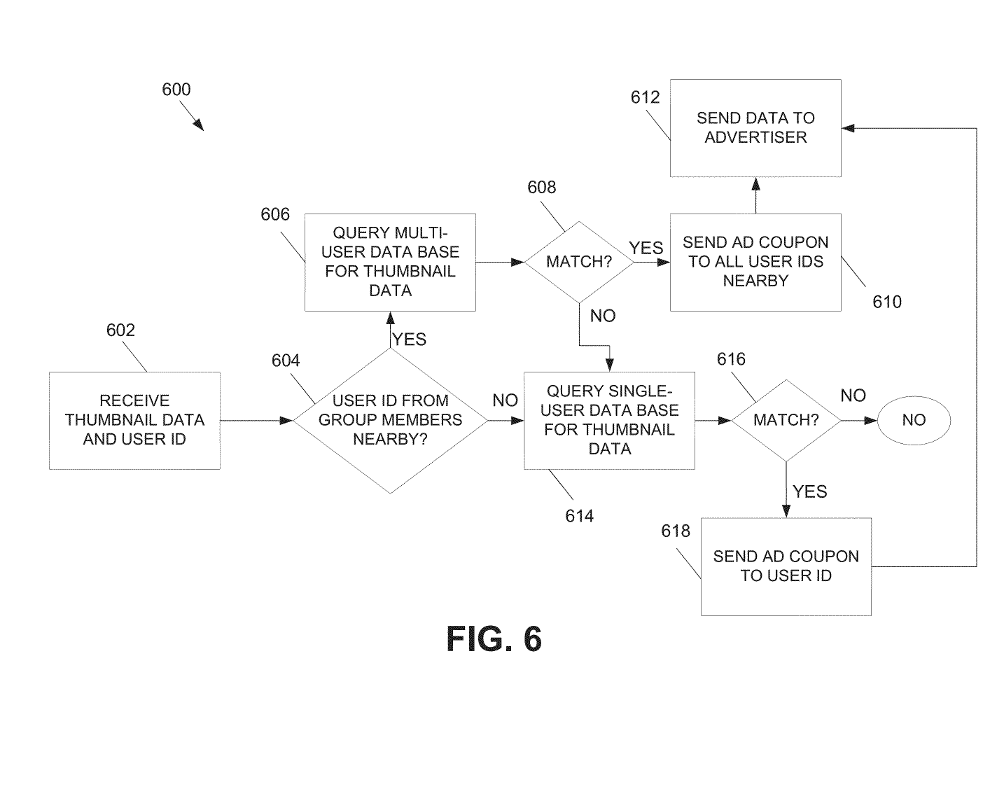

FIG. 6 is a flow diagram that illustrates an example wearable data based targeting method 600 in accordance with an embodiment of the invention. The method 600 may be carried out by a POS computing device (e.g., computing device 14), or another computing device (e.g., the computing device 16) in some embodiments. In the flow diagram depicted in FIG. 6, the method 600 generally provides a healthy group discount among multiple users. In other words, a discount is to be offered when groups of persons (e.g., friends, colleagues, etc.) visit a shop at the same time. The method offers them a discount or even an enhanced discount when their total healthy habit level (other habits) has satisfied a certain condition (e.g., has met or exceeded a predetermined threshold). The method 600 begins by receiving thumbnail data and a user ID (602). For instance, the thumbnail data and user ID may be provided by the wearable device 12, the smartphone 18 coupled to the wearable device 12, or accessed over the Internet 21 (e.g. from a server, such as server 20). The method 600 then queries whether user IDs (e.g., from other wearable devices 12) have been detected nearby that also belong to the group associated with the user ID received in 602 (604). The user IDs may all be associated in a data base of the POS computing device, such as according to prior agreement among the users of the group. If yes, the method 600 queries a multi-user data base for the thumbnail data associated with each user of the group (606). The query may be achieved by access to the server 20, a data base coupled to the server 20, or via a local access to a device (e.g., access to memory of the POS computing device 14, the smart TV 16, etc.). The method 600 analyzes the thumbnail data to determine whether the corresponding physiological or behavioral data matches a total value satisfying a predetermined condition (608). For instance, the total value may correspond to points awarded for compliance with a plan and the predetermined condition may correspond to a threshold points target. If there is a match, the method 600 provides information comprising an actionable and measureable incentive based on the awarded points meeting or exceeding the threshold points target (610). For instance, the method 600 may send an advertisement coupon to the members of the group based on the users physiological or behavioral data indicating that the group collectively took more than 10,000 steps that day. The method 600 sends data to the advertiser (e.g., the server 20) (612), such as to update the history of each of the users. Referring to the query at (604), if the query reveals that there are no other group members nearby (No), the method 600 queries a single-user data base for the thumbnail data (614), and determines whether there is a match (e.g., did the user meet or exceed a threshold level of activity or satisfy a threshold level of compliance with a plan) 616. If so, the method 600 sends a coupon to that user (618), otherwise, the method 600 ends.

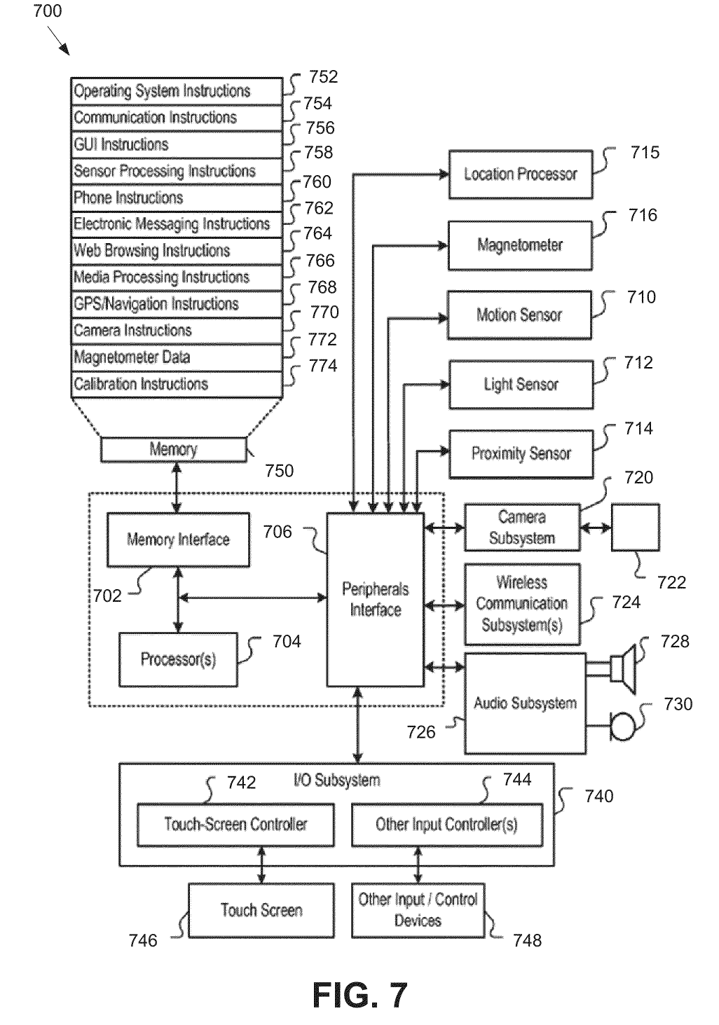

FIG. 7 illustrates a mobile device (e.g., smartphone 18, FIG. 1) architecture that may be utilized to implement the various features and processes described herein. Architecture 700 can be implemented in any number of portable devices including but not limited to wearable devices 12. Architecture 700 as illustrated in FIG. 7 includes a memory interface 702, processors 704, and peripherals interface 706. Memory interface 702, processors 704 and peripherals interface 706 can be separate components or can be integrated as a part of one or more integrated circuits. The various components can be coupled by one or more communication buses or signal lines.

Processors 704 as illustrated in FIG. 7 are meant to be inclusive of data processors, image processors, central processing unit, or any variety of multi-core processing devices. Any variety of sensors, external devices, and external subsystems can be coupled to peripherals interface 706 to facilitate any number of functionalities within the architecture 700 of the mobile device. For example, motion sensor 710, light sensor 712, and proximity sensor 714 can be coupled to peripherals interface 706 to facilitate orientation, lighting, and proximity functions of the mobile device. For example, light sensor 712 could be utilized to facilitate adjusting the brightness of touch surface 746. Motion sensor 710, which could be exemplified in the context of an accelerometer or gyroscope, could be utilized to detect movement and orientation of the mobile device. Display objects or media could then be presented according to a detected orientation (e.g., portrait or landscape).

Other sensors could be coupled to peripherals interface 706, such as a temperature sensor, a biometric sensor, or other sensing device to facilitate corresponding functionalities. Location processor 715 (e.g., a global positioning transceiver) can be coupled to peripherals interface 706 to allow for generation of geo-location data thereby facilitating geo-positioning. An electronic magnetometer 716 such as an integrated circuit chip could in turn be connected to peripherals interface 706 to provide data related to the direction of true magnetic North whereby the mobile device could enjoy compass or directional functionality. Camera subsystem 720 and an optical sensor 722 such as a charged coupled device (CCD) or a complementary metal-oxide semiconductor (CMOS) optical sensor can facilitate camera functions such as recording photographs and video clips.

Communication functionality can be facilitated through one or more communication subsystems 724, which may include one or more wireless communication subsystems. Wireless communication subsystems 724 can include 802.5 or Bluetooth transceivers as well as optical transceivers such as infrared. Wired communication system can include a port device such as a Universal Serial Bus (USB) port or some other wired port connection that can be used to establish a wired coupling to other computing devices such as network access devices, personal computers, printers, displays, or other processing devices capable of receiving or transmitting data. The specific design and implementation of communication subsystem 724 may depend on the communication network or medium over which the device is intended to operate. For example, a device may include wireless communication subsystem designed to operate over a global system for mobile communications (GSM) network, a GPRS network, an enhanced data GSM environment (EDGE) network, 802.5 communication networks, code division multiple access (CDMA) networks, or Bluetooth networks. Communication subsystem 724 may include hosting protocols such that the device may be configured as a base station for other wireless devices. Communication subsystems can also allow the device to synchronize with a host device using one or more protocols such as TCP/IP, HTTP, or UDP.

Audio subsystem 726 can be coupled to a speaker 728 and one or more microphones 730 to facilitate voice-enabled functions. These functions might include voice recognition, voice replication, or digital recording. Audio subsystem 726 in conjunction may also encompass traditional telephony functions.

I/O subsystem 740 may include touch controller 742 and/or other input controller(s) 744. Touch controller 742 can be coupled to a touch surface 746. Touch surface 746 and touch controller 742 may detect contact and movement or break thereof using any of a number of touch sensitivity technologies, including but not limited to capacitive, resistive, infrared, or surface acoustic wave technologies. Other proximity sensor arrays or elements for determining one or more points of contact with touch surface 746 may likewise be utilized. In one implementation, touch surface 746 can display virtual or soft buttons and a virtual keyboard, which can be used as an input/output device by the user.

Other input controllers 744 can be coupled to other input/control devices 748 such as one or more buttons, rocker switches, thumb-wheels, infrared ports, USB ports, and/or a pointer device such as a stylus. The one or more buttons (not shown) can include an up/down button for volume control of speaker 728 and/or microphone 730. In some implementations, device architecture 700 can include the functionality of an audio and/or video playback or recording device and may include a pin connector for tethering to other devices.

Memory interface 702 can be coupled to memory 750. Memory 750 can include high-speed random access memory or non-volatile memory such as magnetic disk storage devices, optical storage devices, or flash memory. Memory 750 may store operating system 752, such as Darwin, RTXC, LINUX, UNIX, OS X, ANDROID, WINDOWS, or an embedded operating system such as VXWorks. Operating system 752 may include instructions for handling basic system services and for performing hardware dependent tasks. In some implementations, operating system 752 can include a kernel.

Memory 750 may also store communication instructions 754 to facilitate communicating with other mobile computing devices or servers. Communication instructions 754 can also be used to select an operational mode or communication medium for use by the device based on a geographic location, which could be obtained by the GPS/Navigation instructions 768. Memory 750 may include graphical user interface instructions 756 to facilitate graphic user interface processing such as the generation of an interface; sensor processing instructions 758 to facilitate sensor-related processing and functions; phone instructions 760 to facilitate phone-related processes and functions; electronic messaging instructions 762 to facilitate electronic-messaging related processes and functions; web browsing instructions 764 to facilitate web browsing-related processes and functions; media processing instructions 766 to facilitate media processing-related processes and functions; GPS/Navigation instructions 768 to facilitate GPS and navigation-related processes, camera instructions 770 to facilitate camera-related processes and functions; and instructions 772 for any other application that may be operating on or in conjunction with the mobile computing device. Memory 750 may also store other software instructions for facilitating other processes, features and applications, such as applications related to navigation, social networking, location-based services or map displays.

Each of the above identified instructions and applications can correspond to a set of instructions for performing one or more functions described above. These instructions need not be implemented as separate software programs, procedures, or modules. Memory 750 can include additional or fewer instructions. Furthermore, various functions of the mobile device may be implemented in hardware and/or in software, including in one or more signal processing and/or application specific integrated circuits.

Certain features may be implemented in a computer system that includes a back-end component, such as a data server, that includes a middleware component, such as an application server or an Internet server, or that includes a front-end component, such as a client computer having a graphical user interface or an Internet browser, or any combination of the foregoing. The components of the system can be connected by any form or medium of digital data communication such as a communication network. Some examples of communication networks include LAN, WAN and the computers and networks forming the Internet. The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an API that can define one or more parameters that are passed between a calling application and other software code such as an operating system, library routine, function that provides a service, that provides data, or that performs an operation or a computation. The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer may employ to access functions supporting the API. In some implementations, an API call can report to an application the capabilities of a device running the application, such as input capability, output capability, processing capability, power capability, and communications capability.

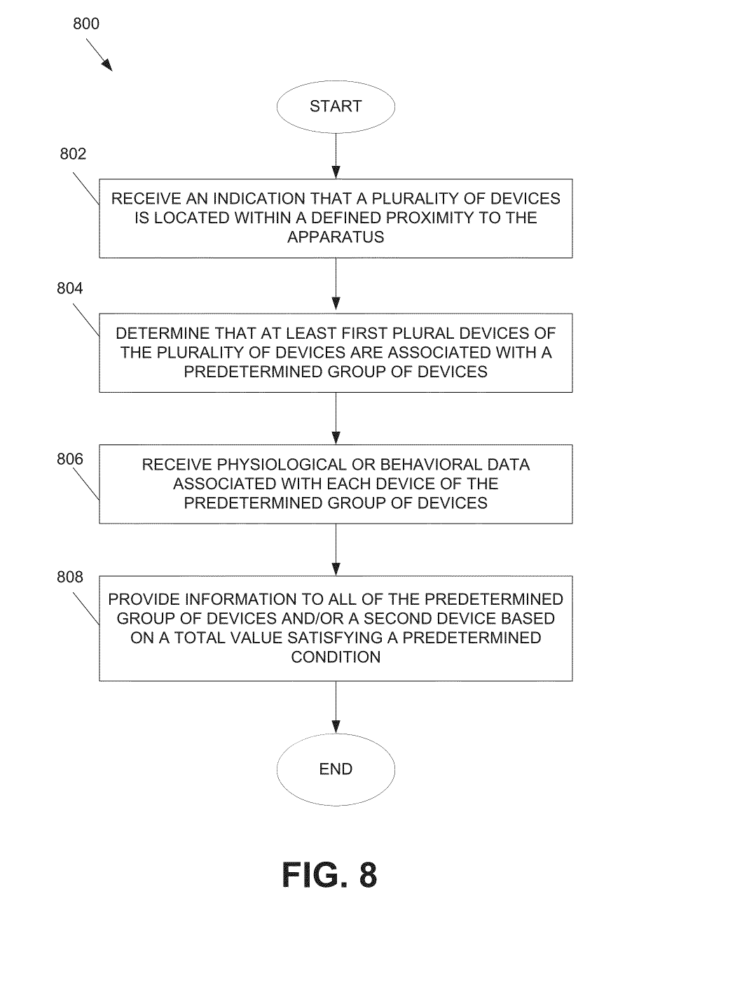

FIGS. 8-10 illustrate some additional embodiments of wearable data based targeting methods. The method illustrated in FIG. 8, denoted as method 800, is related to the method described in association with FIG. 6, and may be implemented by the POS computing device 14 (e.g., a processor running software in the POS computing device 14). In one embodiment, the method 800 comprises receive an indication that a plurality of devices is located within a defined proximity to an apparatus (802); determining that at least first plural devices of the plurality of devices are associated with a predetermined group of devices (804); receiving physiological or behavioral data associated with each device of the predetermined group of devices (806); and providing information to all of the predetermined group of devices, a second device, or a combination of all of the predetermined group of devices and the second device based on a total value corresponding to the received physiological or behavioral data satisfying a predetermined condition (808). Note that the second device may be a display screen or other user interface device located in a store that presents the information to a user, where the information may be motivational information, incentives (e.g., purchasing incentives, such as discounts, promotions, etc.), etc. An indication of proximity of the plurality of devices to the apparatus (e.g., hosting the processor running the POS computing device 14) may be achieved via the receipt of thumbnail data, via trilateration using the reception of signals in the store from the wearable device or coupled smartphone), or using other wireless signaling techniques (e.g., RSSI, GNSS, etc.).

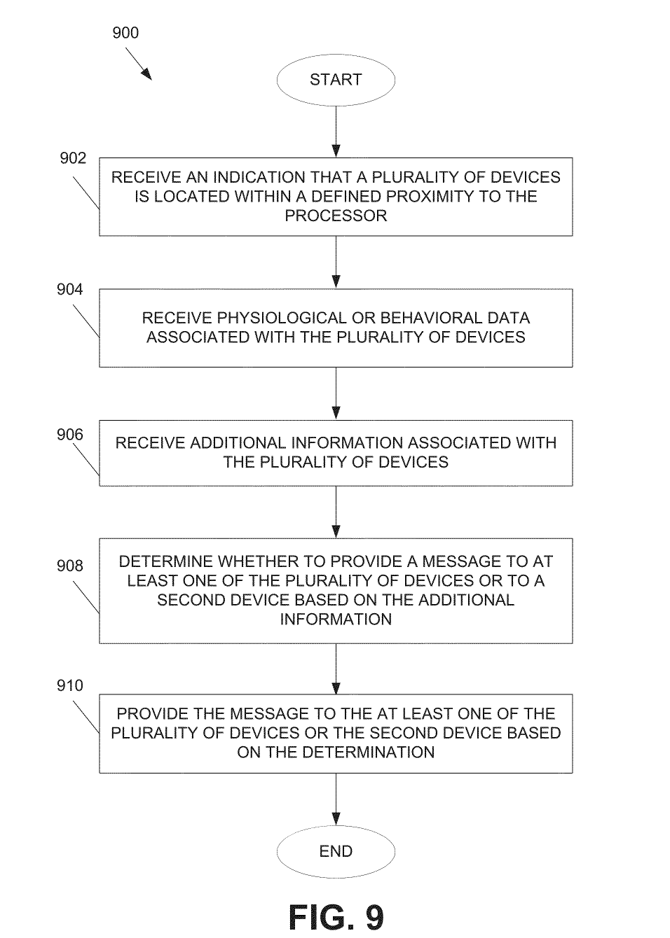

The method of FIG. 9, denoted as method 900, involves an issue of dealing with multiple wearables/viewers within range of beacon, in case of smart TV screen at home or a display screen in a shop. In other words, one question that arises is, when there are multiple users with wearables in proximity to a user interface device, such as a display screen, who should be targeted with messages (e.g., who receives VIP treatment)? Upon simultaneous detection of multiple wearables/viewers within range of beacons and/or a display screen, several message delivery scenarios are contemplated. In one embodiment, private message(s) may be presented on each user's wearable, with content tailored (e.g., user-specific information) to each user's own goals. Such content may be advice for the user, or coupons or other incentives based on compliance or performance relative to a plan (e.g., health plan). When multiple users are detected to be in vicinity of a beacon, the method 900 may decide to deliver user specific messages only via each respective user's private screen (e.g., the display screen of the wearable device 12 or smartphone 18, FIG. 1). The method 900 may be implemented by the POS computing device 14 or the smart TV 16 (e.g., by a processor(s) running software within each device). With reference to the method of FIG. 9, the method 900 comprises receiving an indication that a plurality of devices is located within a defined proximity to the processor (902); receiving physiological or behavioral data associated with the plurality of devices (904); receiving additional information associated with the plurality of devices (906); determine whether to provide a message to at least one of the plurality of devices or to a second device based on the additional information (908); and providing the message to the at least one of the plurality of devices or the second device based on the determination (910). In the method 900, the second device may be, for instance, one or more user interface devices (e.g., display screens, speakers, etc.) located in the store, and the additional information may be device information, such as whether the wearable device for which the physiological or behavioral data is associated, has a display screen. The physiological or behavioral data may be communicated from the wearable device 12, a smartphone 18 coupled to the wearable device 12, or accessed via the network 21 (FIG. 1). Note that the additional information may include one or more information associated with the thumbnail data, such as device information, friends information, member ID, etc.

Variations to the method 900 described above are also contemplated to be within the scope of the disclosure. In one embodiment, a public message may be presented via a nearable (e.g., toothbrush, coffee maker, pill box, etc.) for the user with corresponding physiological or behavioral data most compliant with his or her plan (e.g., health plan), and/or for the user that had been following past advices (e.g., based on a match of prior advice and historical purchases and compliance thereto) and/or for rewarding a returning customer. In some embodiments, if the users within beacon range have been determined to possess a common goal or interest, then a common message may be formulated that interests both (or all).

In some embodiments, the messaging provided by the computing device may be to not only influence a purchasing behavior but also to enhance a particular habit (e.g., healthy habit behavior). For instance, if users are involved in some kind of health improvement plan, then the coupons to be earned are fashioned to be in line with the plan. Stated otherwise, the computing device may use the current health plan of a user to act as a filter to decide the discount for which product or service to be offered (e.g., running shoes or umbrella, in case of an activity enhancement plan).

In some embodiments, the computing device may provide compliance-dependent messaging, as disclosed above. For instance, the computing device may monitor whether prior advice has been followed by comparing message content sent to specific users and buying behavior from that specific user. Such information may be used for deciding future offerings and/or to select between multiple viewers (e.g., multiple viewers detected in front of a display screen or other user interface device), or more particularly, which person to target.

In some embodiments, for messaging among multiple display screens (e.g., second devices) in a single store, the computing device may determine that the content and order of messages displayed via the various screens may depend on each other. For instance, second message content may be different based on the first message content, and the second display screen is aware of the message displayed on the first display screen and adapts accordingly.

In some embodiments, the message feed may be implemented according to a single display screen, and when the customer is in the store proximal to the display screen for a longer period of time (e.g., longer in duration than a predetermined threshold), the message rendered via the same display screen may be chosen dependent on previous messages displayed via the same display screen.

Note that, in some embodiments, the second devices are not bounded by physical boundaries. That is, if the user goes from one store to the other, the message displayed in second store (or webpage) can still take into account what was shown on a first (e.g., physical, brick and mortar) store, since many users browse in the physical world, and shop online, or vice versa (and also, users often first visit several shops before deciding on buying something).

In some embodiments, a profile-based messaging may be implemented, where the promotional messages to the user can be selected or tuned to fit the profile of the user, as known from his or her user ID. For instance, if the computing device determined from the profile that the user has a very high body mass index (BMI) and/or other physiological feature, then the picture elements in the messages delivered to this user may be selected or adapted to show only people with BMI values that are not deviating too much from the user.

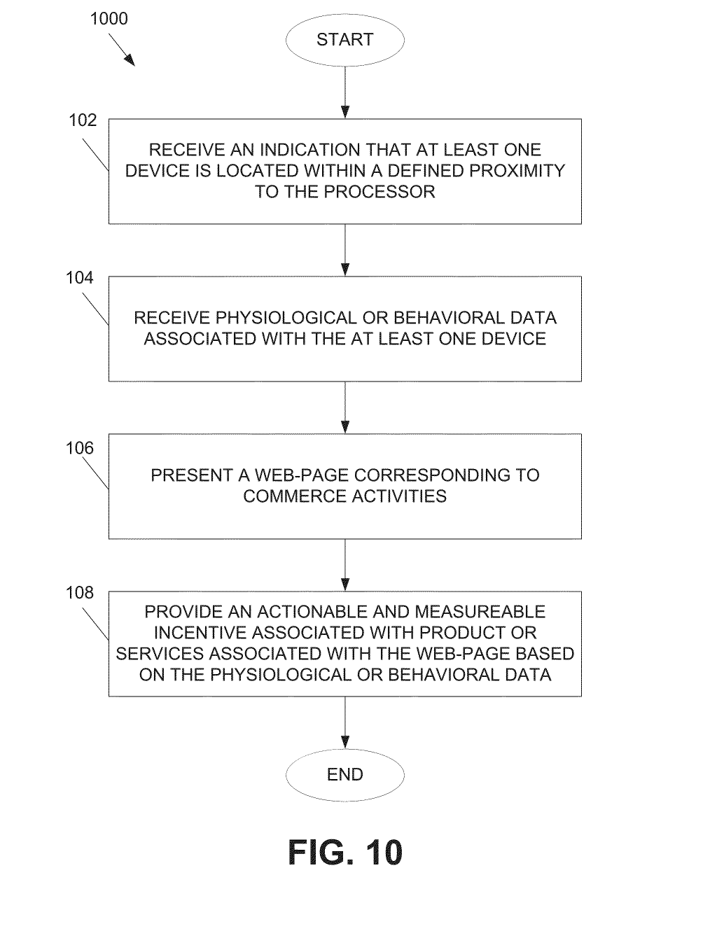

Referring now to FIG. 10, shown is a method 1000 that is directed to a Webshop proximity marketing method. In other words, the wearable data may be used by the smart TV 16 to determine or select promotions for the wearable devices 12 detected within proximity to the smart TV 16 and offered during web shopping. For instance, when visiting a specific web shop, a link may be established to data from the wearable device 12 worn by the user (e.g., making use of short range wireless connection, such as a Bluetooth link between the wearable device 12 and the smart TV 16, or other computing devices 16 (e.g., laptop, desktop, tablet, etc.)). The method 1000 may be implemented by the smart TV 16 (or other computing device located within a home or other facility to enable Web-based shopping). As depicted in FIG. 10, the method 1000 comprises receiving an indication that at least one device is located within a defined proximity to the processor (1002); receive physiological or behavioral data associated with the at least one device (1004); present a web-page corresponding to commerce activities (1006); and provide an actionable and measureable incentive associated with product or services associated with the web-page based on the physiological or behavioral data (1008).

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described example embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

At least the following is claimed:

1. An apparatus, comprising:
a processor configured to:
receive an indication that a plurality of devices is located within a defined proximity to the apparatus;
determine that at least first plural devices of the plurality of devices are associated with a predetermined group of devices;
receive physiological or behavioral data associated with each device of the predetermined group of devices; and
provide information to all of the predetermined group of devices, a second device, or a combination of all of the predetermined group of devices and the second device based on a total value corresponding to the received physiological or behavioral data satisfying a predetermined condition.

2. The apparatus of claim 1, wherein the total value corresponds to points awarded for compliance with a plan and the predetermined condition corresponds to a threshold points target, wherein the processor is configured to provide the information comprising an actionable and measureable incentive based on the awarded points meeting or exceeding the threshold points target.

3. A system, comprising:
a processor configured to:
receive an indication that a plurality of devices is located within a defined proximity to the processor;
receive physiological or behavioral data associated with the plurality of devices;
receive additional information associated with the plurality of devices;
determine whether to provide a message to at least one of the plurality of devices or to a second device based on the additional information; and
provide the message to the at least one of the plurality of devices or the second device based on the determination.

4. The system of claim 3, wherein the processor is further configured to, based on the additional information indicating that the plurality of devices comprises respective display screens, provide respective user-specific messages to the plurality of devices.

5. The system of claim 3, wherein the processor is hosted by a computing device, the plurality of devices each comprises a wearable device worn by a person, and the second device comprises a user interface device exposed to persons associated respectively with each of the plurality of devices, the user interface device comprising audio, visual, or a combination of audio and visual components.

6. The system of claim 5, wherein the user interface device further comprises a nearable device.

7. The system of claim 3, wherein the processor is further configured to, based on the additional information indicating that the plurality of devices comprise respective display screens, further receive an indication of a quantity of the plurality of devices located within a defined distance from the second device, and based on the quantity equaling one, provide a user-specific message associated with one of the plurality of devices to the second device, the one of the plurality of devices located within the defined distance from the second device.

8. The system of claim 3, wherein the processor is further configured to, based on the additional information indicating that the plurality of devices comprise respective display screens, further receive an indication of a quantity of the plurality of devices located within a defined distance from the second device, and based on the quantity equaling more than one, provide a user-specific message associated with each of the plurality of devices to the respective plurality of devices.

9. The system of claim 3, wherein the processor is further configured to, based on the additional information indicating that the plurality of devices comprise respective display screens, further receive an indication of a quantity of the plurality of devices located within a defined distance from the second device, and based on the quantity equaling more than one:
provide a user-specific message associated with one of the plurality of devices to the second device and provide one or more respective user-specific messages to any other of the plurality of devices based on a comparison of the physiological or behavioral data associated with the one of the plurality of devices and the any other of the plurality of devices to respective plans, the one of the plurality of devices and the any other of the plurality of devices located within the defined distance from the second device.

10. The system of claim 9, wherein the processor is configured to select the one of the plurality of devices based on a determination that the physiological or behavioral data associated with the one of the plurality of devices indicates closer compliance with the respective plan than a relative compliance of the physiological or behavioral data associated with the any other of the plurality of devices to the respective plan.

11. The system of claim 3, wherein the processor is further configured to, based on the additional information indicating that the plurality of devices comprise respective display screens and the additional information further indicating past activities associated with users of the plurality of devices, further receive an indication of a quantity of the plurality of devices located within a defined distance from the second device, and based on the quantity equaling more than one:
provide a user-specific message associated with one of the plurality of devices to the second device and provide one or more respective user-specific messages to any other of the plurality of devices based on a comparison of the past activities associated with the one of the plurality of devices and the any other of the plurality of devices to respective plans, the one of the plurality of devices and the any other of the plurality of devices located within the defined distance from the second device.

12. The system of claim 11, wherein the processor is configured to select the one of the plurality of devices based on a determination that the past activities associated with the one of the plurality of devices has a greater redeeming value than the past activities of the any other of the plurality of devices.

13. The system of claim 3, wherein the processor is further configured to, based on the additional information indicating that the plurality of devices comprise respective display screens and the additional information further indicating past activities associated with users of the plurality of devices and past messaging comprising advice, further receive an indication of a quantity of the plurality of devices located within a defined distance from the second device, and based on the quantity equaling more than one:
provide a user-specific message associated with only one of the plurality of devices to the second device based on a determination that there is a closer correlation between the past activities and the corresponding advice for the one of the plurality of devices when compared to the other of the plurality of devices, the one of the plurality of devices and the other of the plurality of devices located within the defined distance from the second device.

14. The system of claim 3, wherein the processor is further configured to, based on the additional information indicating that the plurality of devices comprise respective display screens, further receive an indication of a quantity of the plurality of devices located within a defined distance from the second device, and based on the quantity equaling more than one:
provide the message to the second device, wherein a content of the message provides a common interest to persons associated with the plurality of devices located with the defined distance, the content based on a comparison of the physiological and behavioral data associated with the plurality of devices located with the defined distance.

15. The system of claim 3, wherein the message comprises a coupon, and wherein the processor is further configured to provide the coupon with a value that differs based on a level a user associated with one of the plurality of devices has achieved relative to one or more target parameter values corresponding to the received physiological or behavioral data.

16. The system of claim 3, wherein the second device comprises a display screen communicatively coupled to the processor, and further including a second display screen communicatively coupled to the processor, wherein the processor is configured to provide the message to the display screen and the second display screen, wherein a content, order of presentation, or a combination of the content and the order of presentation of the message provided to the second display screen is dependent on the message provided to the display screen.

17. The system of claim 3, wherein the processor is further configured to provide multiple messages to the second device having different content, the processor configured to present the multiple messages based on an indication received by the processor that one of the plurality of devices is located within a defined distance from the second device over threshold period of time.

18. The system of claim 3, wherein the second device comprises a display screen communicatively coupled to the processor, wherein the motivational content comprises image data of a person, wherein the processor is configured to select the image data according to the physiological data comprising a physiological feature of a user associated with one of the plurality of devices, the image data, when rendered on the display screen, having an image of a person with a comparable physiological feature to the physiological feature of the user.

19. An apparatus, comprising:
a display screen;
a processor coupled to the display screen, the processor configured to:
receive an indication that at least one device is located within a defined proximity to the processor;
receive physiological or behavioral data associated with the at least one device;
present a web-page corresponding to commerce activities; and
provide an actionable and measureable incentive associated with product or services associated with the web-page based on the physiological or behavioral data.

20. The apparatus of claim 19, wherein the processor is further configured to cause the display of the web page based on the received physiological or behavioral data.
